(19) United States
(12) Patent Application Publication
(10) Pub. No.: US 2010/0194211 A1
(43) Pub. Date: Aug. 5, 2010

(54) DEVICE AND METHOD FOR PROCESSING, RECEIVING AND/OR INSTALLING AN ELECTRICAL CONDUCTOR

(75) Inventors: Peter Funken, Wuppertal (DE); Christian Rosin, Reichling (DE)

Correspondence Address: KELLY LOWRY & KELLEY, LLP, 6320 CANOGA AVENUE, SUITE 1650, WOODLAND HILLS, CA, 91367, US

(73) Assignee: DRAKA INDUSTRIAL CABLE GMBH, Wuppertal (DE)

(21) Appl. No.: 11/994,373

(22) PCT Filed: Jul. 3, 2006
(86) PCT No.: PCT/EP2006/006448

§ 371 Date: Jul. 29, 2008

(30) Foreign Application Priority Data
Jul. 6, 2005 (DE) DE202005031844.4
Feb. 3, 2006 (DE) DE102006005406.7
Jun. 20, 2006 (DE) DE102006028354.6

(51) Int. Cl. H02K 41/02; H02K 15/06; H02K 3/28

(52) U.S. Cl. 310/12.02; 29/596; 29/732

(57) ABSTRACT

A travelling-field electrical conductor is provided for a linear motor, wherein the electrical conductor includes at least one train of windings, such that processing, conveying and/or outfitting of the electrical conductor can be carried out particularly efficiently, economically and precisely. The electrical conductor is made available in a regulated manner, in particular from at least one source of supply, for example from at least one drum. The electrical conductor is also formable in a controlled manner.

### TECHNICAL FIELD

The present invention generally relates to the technical field of production and/or installation of electrical conductors, in particular of industrial cables.

More specifically, the present invention relates to a processing device according to the precharacterising part of claim 1; to a device, in particular an installation device, according to the precharacterising part of claim 10; as well as to a method for processing at least one electrical conductor, in particular at least one travelling-field conductor, for example at least one train of windings, provided for at least one linear motor, wherein said electrical conductor comprises at least one electrical line.

For example, the present invention relates to the production and laying of the train of windings of a linear motor.

### PRIOR ART

The term linear motor or travelling-field motor refers to an electrical drive motor which is, for example, used as a non-contacting drive of a magnetic levitation train.

In such a magnetic levitation train the trains of windings or the cable windings of the linear motor are installed in the track. If electrical current is fed to the trains of windings, a magnetic travelling field is generated by means of which the vehicle is pulled along in a non-contacting manner.

Electrical lines for the alternating current winding of a linear motor are, for example, known from printed publication DE 196 38 603 A1 or from printed publication DE 196 44 870 A1.

A device for connecting the electrically conductive sheath of an electrical line with an earth conductor, which line has been inserted into the grooves of the inductor of a linear motor, is disclosed in printed publication WO 97/16881 A1 .

Furthermore, several systems for the production and laying of the trains of windings of a linear motor are known. Methods and devices are already known

for the installation of prefabricated three-phase windings directly on the construction site, as well as

for the production and installation of single-phase windings directly on the construction site.

In the known systems, as a rule, at least part of the activities have to be carried out under construction site conditions. Consequently, the known systems for the production and laying of the cable windings of linear motors are associated with all the qualitative disadvantages of a construction site process.

A method for the production of a three-phase alternating current winding for a linear motor, in which to a very large extent the trains of windings can be made in the factory, is known from EP 1 542 341 A1.

However, in this known method only the process of winding but not the process of laying the trains of windings takes place in the factory. Instead, the trains of windings are installed in the stator directly on the construction site or at the place of installation of the section of track.

Furthermore, from printed publication DE 103 46 105 A1 a method for constructing a section of track for a magnetic levitation vehicle that can be driven by an electrical linear motor is known.

In this known method, units that comprise sections of the girder with the stator, including associated trains of windings affixed thereto, are prefabricated at the factory and are assembled at the point of installation by means of plug-type connections to the section of track.

Furthermore, prefabrication or the outfitting of travel way girders with electrical conductors formed in the manner of a long stator winding (LSW) under workshop conditions is known.

However, known systems cannot fully meet the specified system requirements of a linear motor drive; in particular, in conventional systems different spacing between the winding heads and the stator can cause asymmetries in the three-phase system.

Since, due to the spatial design of the excitation winding arranged in the grooves of the stator, the distance between the individual phases and the stator core is different, asymmetries result.

Due to the physical necessity of leading the windings of each phase past each other, the individual trains of windings are in different spatial positions in relation to each other.

As a result of local asymmetries in the three-phase synchronous motor in the case of different spatial laying as dictated by the system, different current fields and voltage differences are generated in the individual phases of the linear motor; these different current fields and voltages generate losses in the drive system.

Known processes for the production of three-phase windings for a linear motor thus do not provide an economic solution for evening out the different field designs of the three individual phases.

Continuously laid three-phase windings according to prior art are associated with a further disadvantage in that there is a physical necessity to provide an expansion gap 66n across the girder transitions 66 (compare FIGS. 5A and 5B).

This results in discontinuity of the long stator, which discontinuity is due to the absence of a stator tooth at each girder transition 66. For reasons of continuity a winding of the electrical conductor, which winding has been produced with known methods, cannot be interrupted; the electrical conductor according to prior art is therefore installed through this gap 66n in the free space.

Only extensive planning steps or discontinuity methods are known by means of which a situation can be prevented in which a lower train of windings or a lower layer UL of the motor winding 40 is situated in the free groove 66n.

However, despite corresponding calculations, in practical application this discontinuity is not always implemented; therefore the end stator packets of the adjacent girders 60 are, as a rule, subsequently interchanged.

According to prior art, the middle train of windings or the middle layer ML, as well as the upper train of windings or the upper layer UL of the three-phase winding, is or are always laid through the expansion gap 66n in the free space; for this reason these two layers ML, UL, in particular the middle layer ML, cannot be laid so as to be permanently in a stable position.

Instead, according to prior art at least the middle train of windings or the middle layer ML has to be additionally attached using cable ties, which results in corresponding additional expenditure. However, it is not possible to achieve a permanent connection with the use of a cable tie, so that expensive upkeep is required.

Furthermore, the costs of materials and energy associated with the production and installation of the train of windings in known systems are very substantial.

Presentation of the Present Invention: Object, Solution, Advantages

Based on the disadvantages and deficiencies described above, and taking into account prior art as set out, it is the object of the present invention to improve a processing device of the type mentioned in the introduction, a device of the type mentioned in the introduction, as well as a method of the type mentioned in the introduction, such that processing, conveying and/or outfitting the electrical conductor can be carried out particularly efficiently, economically and precisely.

This object is met by a processing device with the characteristics stated in claim 1, by a device with the characteristics stated in claim 10, as well as by a method with the characteristics stated in claim 14. Advantageous embodiments and expedient improvements of the present invention are characterised in the respective subordinate claims.

at least one third phase, for instance at least one upper layer are formed; in particular the processing device is designed to form the electrical conductor in the manner of a long stator winding (LSW).

Moreover, the processing device is advantageously designed, after completion of the forming process, to separate from the source of supply the electrical conductor into sections, in particular into sections of specified length, for example to cut said electrical conductor off.

In this way individual girder installation of the electrical conductor and thus stable laying of the electrical conductor at the girder transition becomes possible. In contrast to prior art it is thus not necessary to lay the electrical conductor in the free space through an expansion gap.

In an expedient embodiment of the present invention the processing device is protected, by at least one surface, in particular by a roof, from external influences, in particular from influences of the weather.

The processing device can be situated in a hall, for example in a girder outfitting hall. This offers an advantage in that outfitting the girder with the electrical conductor, in particular producing and laying the electrical conductor, is not impeded by construction site processes.

Advantageously, the processing device can be moved, in particular traversed, in transverse direction to the axis of at least one girder that is to be outfitted with the electrical conductor, in particular of at least one stator of the linear motor, for example at least one carriageway girder or travel way girder, predominantly comprising steel and/or concrete, of a magnetic levitation train. In this way, controlled forming of the electrical conductor is facilitated.

According to a preferred embodiment of the present invention, the processing device is designed to carry out forming of the electrical conductor irrespective of the spatial orientation of the processing device.

The present invention is based on the principle that the electrical conductor, by means of at least one processing device, is

provided in a controlled manner, in particular removed from at least one source of supply, for example from at least one drum, and/or

formed in a controlled manner, in particular aligned as at least one long stator winding (LSW) and/or bent and/or crimped and/or wound.

According to an advantageous exemplary embodiment of the present invention the processing device is designed to regulate the supply of the non-formed electrical conductor by means of at least one control system, in particular by means of at least one computer-assisted integrated management system (IMS). The processing device is thus preferably automatically able to supply the required quantity of non-bent electrical connector before and/or during and/or after the forming process.

Furthermore, optionally, the supply device feeds the electrical conductor according to the specifications of the control system, in particular in a bending process and/or crimping process. To this purpose the control system can be designed to acquire and/or to determine data and/or information that are/is relevant to the processing of the electrical conductor.

In this way the processing device can regulate the forming of the electrical conductor, which is preferably wound in a meandering fashion, in particular the number of the meandering shapes; in particular, the processing device is in a position, preferably automatically to supply the required number of meandering shapes.

The processing device can, for example, be designed as a single-phase and/or three-phase plant, for example, for single-phase and/or for three-phase winding of the electrical conductor.

In the case of three-phase winding, for example,

at least one first phase, for instance at least one lower layer,

at least one second phase, for instance at least one middle layer, and

Preferably, the (single-phase and/or three-phase) winding of the electrical conductor can, for example, be produced and/or conveyed in the position of use and/or in a head-down position and/or in a lateral position, which is in particular made possible in that the processing device due to its installation and design in a hall is not tied to a track.

For example, in the case of a concept involving the production of individual phases to be placed to stock, the receiving device can be designed so as to swivel by ninety degrees in order to create space for several individual phases, before these individual phases are pressed-in in the position of use or in the head-down position.

Irrespective of this or in conjunction with this, in an advantageous embodiment of the present invention the shape of the formed electrical conductor can be stabilised with the use of at least one stabilising means.

For example, during the forming process, or after completion of the forming process, in particular during or after completion of producing the winding, the processing device can use the stabilising means as an agent to improve the ability of the electrical conductor to keep its shape, which electrical conductor is preferably wound in a meandering fashion.

The present invention furthermore comprises at least one receiving device for receiving, in particular at least one conveyor device for conveying the electrical conductor that has been provided and/or formed by a processing device according to the type disclosed above.

Expediently, the receiving device communicates with the processing device; in particular the receiving device can be interlinked with the processing device.

Advantageously the processing device is designed to convey the electrical conductor to the receiving device, in particular after completion of the forming process. In this arrangement the receiving device is preferably designed to receive the electrical conductor irrespective of the spatial orientation of the receiving device.

For example, the receiving device can receive the electrical conductor, in particular the winding, in the position of use and/or in head-down position and/or in lateral position. Transport of the electrical conductor, which is in particular a formed conductor, which transport is made possible by the receiving device, expediently takes place after completion of the forming process, in particular after completion of producing the winding.

Irrespective of this, or in conjunction with this, the receiving device is advantageously designed to rotate on its own axis, so as to, for example, take up a desired position for attachment, in particular for installation, of the electrical conductor.

In an expedient embodiment of the present invention, the receiving device is protected against external influences, in particular the effect of the weather, by at least one surface, in particular by a roof.

The receiving device can be located in a hall, for example in the girder outfitting hall. This provides an advantage in that outfitting the girder with the electrical conductor, in particular the production and laying of the electrical conductor, is not impeded by any construction site processes.

The receiving device can, for example, be arranged on the floor, in particular on the hall floor.

Moreover, the receiving device can be arranged on the girder to be outfitted; for example, the receiving device can be supported by the girder to be outfitted.

However, furthermore, the receiving device can also be arranged on the surface that protects it against external influences; in particular the receiving device can be suspended from the hall structure.

Advantageously the receiving device is movable, in particular traversable in longitudinal direction in relation to the axis of the girder to be outfitted. In this way the formed electrical conductor can be transported to the girder. In this arrangement the receiving device can, for example, be a conveyor belt, a tensioning device, a chain or some other device.

The receiving device can be designed in one piece or it can be of modular design. Furthermore, the receiving device can comprise at least one drive of its own, and can, for example, be designed to ensure advancement.

Furthermore, the present invention comprises at least one outfitting device, in particular at least one laying device, for example, at least one impression device for placement of the electrical conductor, in particular after completion of the forming process, on and/or in the girder.

Expediently the outfitting device communicates with the receiving device; in particular, the outfitting device can be interlinked with the receiving device. Advantageously the receiving device is designed to transfer the electrical conductor, in particular at the desired installation location, to the outfitting device.

Independently of the above or in conjunction with the above, the outfitting device can be designed to divide the electrical conductor, after completion of attaching the electrical conductor to the girder and/or in the girder, into sections, in particular into sections of a specified length from the supply, for example to cut the electrical conductor.

Advantageously the outfitting device is designed for wiring, in particular for connecting or interlinking, for example by means of sleeves, the respective phases of the sections of the electrical conductor.

In this process, expediently, at least two of the respective phases of the sections of the electrical conductor can be wired so as to alternate or be transposed, in particular crosswise, so that the assembled electrical conductor comprises the three phases (=lower layer LL, middle layer ML, upper layer UL) in even fractions; in particular, the long stator winding is preferably wound as follows

approximately a third in the manner of the first phase (lower layer LL),

approximately a third in the manner of the second phase (middle layer ML), and

approximately a third in the manner of the third phase (upper layer UL).

One embodiment of the present invention solves the above-described problem of irregular field design of the three individual phases by an advantageous option of any planned transposition of the position of the phases. In this advantageous embodiment this can, however, be achieved without any additional expenditure.

As a result of this advantageous option of a planned transposition of the position of the phases, all the phases within a section of the linear motor can be laid at a third each of the linear motor section length, in the lower layer, in the middle layer, and in the upper layer, and thus the asymmetries of the three-phase winding can be evened out.

Not having to adhere to the continuity condition of the winding phases thus makes it possible, at a planned position, to implement phase change and thus to even out asymmetries.

In order to prevent voltage differences due to

slight inaccuracies in laying, and/or

the ability of the three-phase electrical conductor to keep its shape

at least one insulating material, for example at least one insulating adhesive piece, can be applied to the contact positions of the respective phases of the electrical conductor.

Advantageously, application of the insulating material, in particular of the insulating adhesive piece, takes place automatically by means of the control system.

Furthermore, the insulating material, in particular the insulating adhesive piece, can also serve as a stabilisation means, i.e. it can assume a stabilising function in several application cases. This makes it possible, for example, to implement a prefabricated dimensionally stable three-phase long stator winding LSW that can be placed in one process step into stator packets of the girder.

This results in advantages of shorter laying times, more compact storage options, for example storage in a three-phase LSW instead of three separate LSWs, as well as in facilitated logistics.

Furthermore, the stability of the winding heads in the inserted state during operation can be improved, and thus the danger of form stability of the individual winding heads over time leading to infringement of the free space can be reduced.

In an expedient embodiment of the present invention the girder can comprise a singly-formed electrical conductor and/or a multiply-formed electrical conductor. Advantageously the outfitting device is designed to impress onto the girder either individual meandering shapes or several meandering shapes at the same time.

By means of the spatial design option, for example in a hall, an advantageous embodiment of the present invention makes it possible to assign several stator packets in one process step. In contrast to this, the procedure according to prior art is limited to outfitting one stator packet.

Optionally, the outfitting device according to the present invention can comprise at least one drive and can, for example, be designed to ensure advancement. This advantageous embodiment of the present invention becomes possible by

the availability of adequate space, for example in a hall, and/or

the availability of means, for example by the control system.

Outfitting the girder, in particular the impression process, can, for example, be carried out by means of at least one mechanical device, for instance by means of a rubber wheel and/or by means of at least one pneumatic or hydraulic cylinder, as is optimal in each case.

Advantageously the outfitting device is protected against external influences, in particular against the influences of the weather, by means of at least one surface, in particular by means of a roof.

In this arrangement the outfitting device can be situated in a hall, for example in the girder outfitting hall. This provides an advantage in that outfitting the girder with the electrical conductor, in particular laying the electrical conductor, is not impeded by construction site processes.

The outfitting device can, for example, be arranged on the floor, in particular on the hall floor. Furthermore, the outfitting device can be arranged on the girder to be outfitted, for example, the outfitting device can be supported by the girder to be outfitted.

As a result of the stationary outfitting of the girder in the hall, the girder can be outfitted either in the position of use or in the head-down position, whichever position is more advantageous.

Furthermore, as a result of the spatial design options in a hall, the receiving device can take over the meandering shapes in the position of use and/or in the head-down position, depending on the concept, and can lay said meandering shapes in the girder in combination with the outfitting device.

As a result of the spatial design options in a hall, and as a result of the unlimited selection of drive means, such as, for example, hydraulic units, compressed air and/or electric current, the orientation of the outfitting device can also be oriented on the girder to be outfitted, and at the same time the outfitting device can be traversed independently of the position of the girder on suspension devices or on running gear.

According to a preferred embodiment of the present invention the outfitting device is thus designed to carry out outfitting of the girder with the electrical conductor independently of the spatial orientation of the outfitting device. Preferably, the outfitting device can, for example, operate in the position of use and/or in head-down position and/or in lateral position.

According to the present invention the device comprises several functional components, namely at least one processing device according to the type explained above, at least one receiving device according to the type explained above, and at least one outfitting device according to the type explained above.

The processing device, the receiving device, the outfitting device, the device and the method according to the present invention are all associated with an advantage in that all the requirements for designing a linear motor drive, in particular a three-phase and/or synchronous linear motor, can be met in a flexible manner. This arrangement provides a particular advantage in that asymmetries of a three-phase synchronous linear motor can be evened out.

In particular, according to the present invention, it is possible to meet system requirements that methods and devices according to prior art are unable to meet.

Thus, according to an advantageous embodiment of the present invention, for example asymmetries of a three-phase system, which asymmetries are caused by different distances between the winding heads and the stator, can be evened out.

Furthermore, the present invention provides an advantage in that optionally processing and/or receiving and/or outfitting, in particular production and installation, which are all controlled by data processing technology, and which are in particular automated, of the electrical conductor, in particular of the trains of windings, can be implemented, for example

in the case of reduced drive output on steady-speed track sections in order to reduce the costs of materials and energy, and/or

in the case of reduced drive output and short-circuited winding in the region of stations, for example of train stations, of the magnetic levitation train.

In order to provide reduced drive output of the linear motor, according to an advantageous embodiment of the processing device of the present invention and according to an advantageous embodiment of the method of the present invention, the electrical conductor can be provided so as to be non-formed, for example non-wound, in sections, in particular in corresponding pro rata lengths.

Automated production of special drive regions is, for example, desirable in the region of terminals or train stations of the magnetic levitation train. For reasons of safety, in terminals or stations, sections are installed that provide reduced output, such as, for example, approximately 33 per cent output or approximately fifty per cent output.

According to prior art, drive sections in special regions, for instance in terminals, can only be manually laid or equipped. There are two clear space profiles for the free spaces of the transrapid vehicle, namely

a dynamic clear space profile for travel at higher speeds and in the open, as well as

a static clear space profile for travel at low speed, for instance for travel in the terminal or during service and maintenance operations.

Due to the method used, known laying devices are designed for the dynamic clear space profile and are thus spatially not in a position to drive through train stations comprising station platforms. Accordingly, according to prior art, these regions are laid manually.

While a laying technique involving automatic machines for special regions of reduced drive, in which the machine is able to lay partial sections of a motor winding, is already known, due to the method used, it is, however, necessary in this known laying technique to thread down and separate the line after impressing the last meander shape.

Consequently, threading up of the line prior to start, for instance at commencement of a new section, is necessary. This extra time that is required by threading up and threading down is in a particularly poor ratio in relation to the actual laying time. In practical application, manual laying has thus been the more economical alternative in the method according to prior art.

In contrast to this, the device according to the present invention as well as the method according to the invention advantageously make it possible to install at least one girder that has been outfitted in an automated process in train stations and other buildings.

It is thus possible to automatically outfit at least one girder, in particular each of the girders, individually depending on the requirements. Subsequently the electrical conductor, in particular the phase ends of the electrical conductor, is/are expediently connected as planned.

Using the example of a girder that is 24 metres in length and provides fifty per cent drive, according to prior art, for the first girder section that is six metres in length, and for the third girder section that is six metres in length, in each case six metre-phases are produced, in particular in a plant; the phases are then transported to the place of installation, are pressed into the stator grooves with the use of a semi-automatic impression device, and the ends are fixed to the girder with overlength.

Furthermore, according to prior art, in a subsequent work step the individual phases are connected within the girder, by installation teams, to a total of twelve sleeves and connection lines.

In contrast to the above, according to an advantageous embodiment of the present invention, the above-described configuration, i.e. six metres of meandering shape, six metres straight, six metres of meandering shape, six metres straight, are produced in an automated process along the entire girder length, and are then laid.

Advantageously, production of the winding for the partial drive takes place in a continuous manner, without the need for separation and threading down of the line as is necessary in the case of prior art.

According to a particularly advantageous embodiment of the present invention, when the girder is outfitted with a preassembled line, the straight sections are arranged on the girder and/or connected to the girder in particular semi-automatically, by means of at least one attachment means, for instance by means of at least one clip fitting, which attachment means has, for example, been put into place beforehand.

This provides an advantage in that the electrical conductor, in contrast to prior art, does not require fixing to the girder with overlength; instead, advantageously, the straight sections are attached to the prepared clip fittings at the cheeks of the girder.

This principle can be applied to achieve a further advantage, namely for saving material and installation effort on sections of track with less planned drive output required, for example on steady-speed track sections. In this arrangement the percentage of the drive output can preferably be individually designed.

For example, in order to ensure continuous drive at fifty per cent output, expediently on the opposite side of the linear motor drive, which is in particular arranged on the track, the assignment sequence is offset. With this approach the system requirement of the, in particular, redundant drive can be met even under the conditions of a partial drive.

For a single-track section of fifty per cent drive output, for example 1.2 kilometres in length, material savings, for example, in particular of the electrical conductor, for instance of the travelling-field conductor, of up to sixty per cent result.

Independently of the above or in conjunction with the above, the present invention is associated with an advantage in that the electrical conductor is deformable according to various forming types so that the characteristics of the linear motor can be individually selected.

For example, in a preferred embodiment of the present invention at least two forming types, in particular both types A and B of windings, can be implemented according to the requirements of a linear motor drive that is arranged on the left-hand side and on the right-hand side respectively of the track.

Particularly expediently the girder is equipped by means of at least two processing devices, wherein

at least one of the processing devices for forming the electrical conductor is designed according to the first forming type, in particular according to winding type A; and

at least a further one of the processing devices for forming the electrical conductor is designed according to the second forming type, in particular according to winding type B.

A particularly expedient exemplary embodiment of the present invention provides an advantage in that the process parameters during the production and installation of the trains of windings of a linear motor can be held constant, as a result of which the requirements of series production of consistently high quality according to industry standards can be met.

In order to keep the process parameters constant during production and/or laying of the trains of windings of the linear motor, advantageously data that is significant to the production and/or laying of the trains of windings is electronically transmitted, in particular by means of the control unit or integrated management system (IMS).

Such data includes, for example, the girder assignment with stator packets and stator assignment of the drive, broken down for each girder as production parameters for the device, in particular for at least one bending-, crimping- and laying unit (BKV). In this context the term stator assignment refers to the assignment of the girder, in particular of individual grooves of the girder, with corresponding winding phases.

According to this advantageous embodiment, each winding configuration and its assignment to the corresponding girder can be shown in an automated way. A motor winding produced and put in place using this advantageous method ensures that the configuration of the windings put in place meets the specifications.

According to an advantageous embodiment of the present invention all processes and/or equipment are/is defined that make it possible to achieve great flexibility in the implementation of the tracks of a magnetic rail system, for example of a magnetic levitation train.

Advantageously, in addition, all the processes and/or the equipment are/is defined that serve to improve the availability and economy of the track itself as well as of the devices.

The present invention furthermore relates to at least one electrical conductor, in particular a travelling-field conductor, for example a train of windings that can be made available, in particular

formable, for example alignable and/or bendable and/or crimpable and/or windable, and/or

able to be received and/or

attachable in at least one girder, in particular in at least one stator of at least one linear motor, for example in at least one carriageway girder of a magnetic levitation train, which carriageway girder essentially comprises steel and/or concrete

by means of at least one processing device according to the type explained above, and/or

by means of at least one receiving device according to the type explained above, and/or

by means of at least one outfitting device according to the type explained above, and/or

by means of at least one device according to the type explained above, and/or

by means of the method according to the type explained above.

The present invention finally relates to the use of at least one processing device according to the type explained above, and/or to at least one receiving device according to the type explained above, and/or to at least one outfitting device according to the type explained above, and/or to at least one device according to the type explained above, and/or to the method according to the type explained above for producing and/or laying at least one electrical conductor of at least one linear motor, for example for producing and/or installing at least one in particular single-phase and/or three-phase train of windings, on and/or in at least one carriageway girder made of steel and/or made of concrete, of a magnetic levitation train.

The intended use of the present invention thus in particular relates to the flexible processing and/or installation of the electrical conductor of a linear motor, for example the flexible high-quality outfitting of the long stator winding of a magnetic levitation train system.

### BRIEF DESCRIPTION OF THE DRAWINGS

As already explained above, there are various options of advantageously implementing and improving the teachings of the present invention. To this effect, reference is made to the subordinate claims of claim 1, of claim 10 and of claim 14 on the one hand, and further embodiments, characteristics and advantages of the present invention are explained in more detail below with reference to two exemplary embodiments shown in FIGS. 1 to 13B and the other hand.

The following are shown:

FIG. 1 a diagrammatic aspect of a first exemplary embodiment of a device according to the present invention, which device operates according to the method according to the present invention;

FIG. 2 a diagrammatic lateral view of the device shown in FIG. 1;

FIG. 3 a diagrammatic aspect of a second exemplary embodiment of a device according to the present invention, which device operates according to the method according to the present invention;

FIG. 4A a diagrammatic lateral view of a stator packet according to prior art;

FIG. 4B a perspective aspect, obliquely from above, of the stator packet shown in FIG. 4A;

FIG. 12 a diagrammatic view of the two types of windings of the long stator windings shown in FIG. 11;

FIG. 13A a diagrammatic view of a second exemplary embodiment of a long stator winding formed according to the method of the present invention, which winding has been designed to provide reduced drive output; and

FIG. 13B a diagrammatic top view of a girder comprising two long stator windings LSW shown in FIG. 13A.

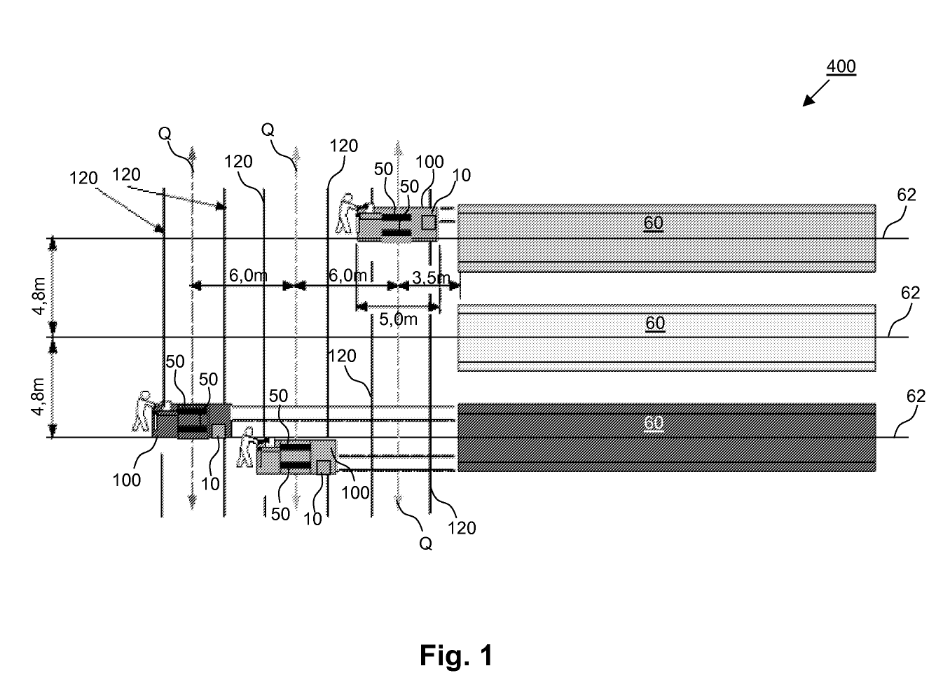

Identical or similar embodiments, elements or characteristics in FIGS. 1 to 13B have the same reference characters.

The Best Way of Implementing the Present Invention

To avoid unnecessary repetition, the following explanations relating to the embodiments, characteristics and advantages of the present invention (unless otherwise stated) relate

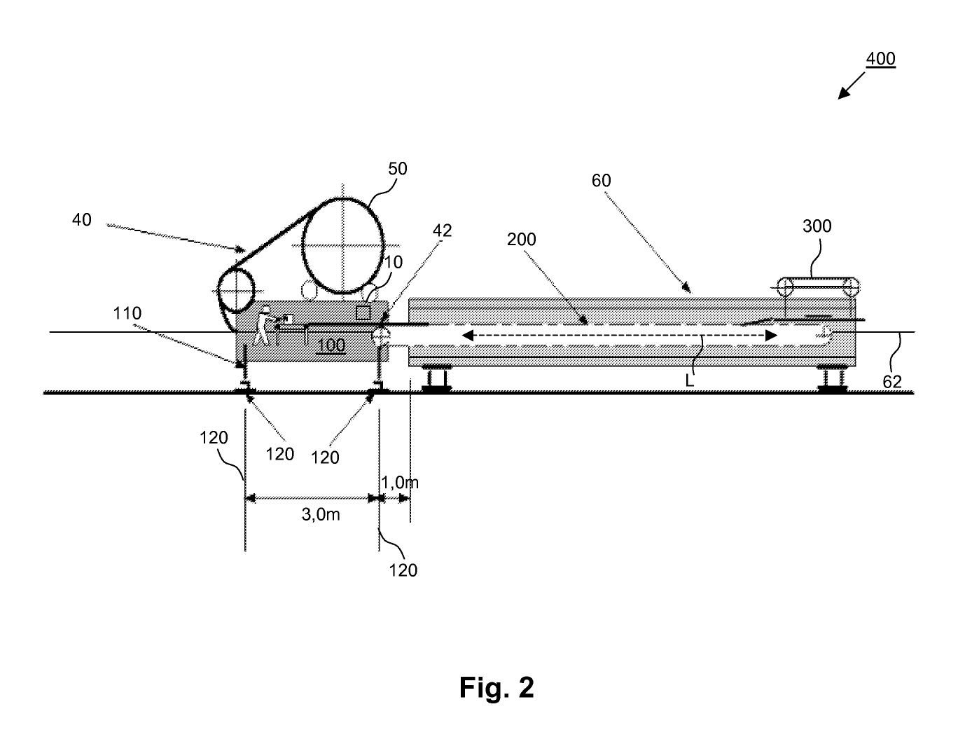

not only to the exemplary embodiment of a device 400 according to the present invention, as shown in FIGS. 1 and 2

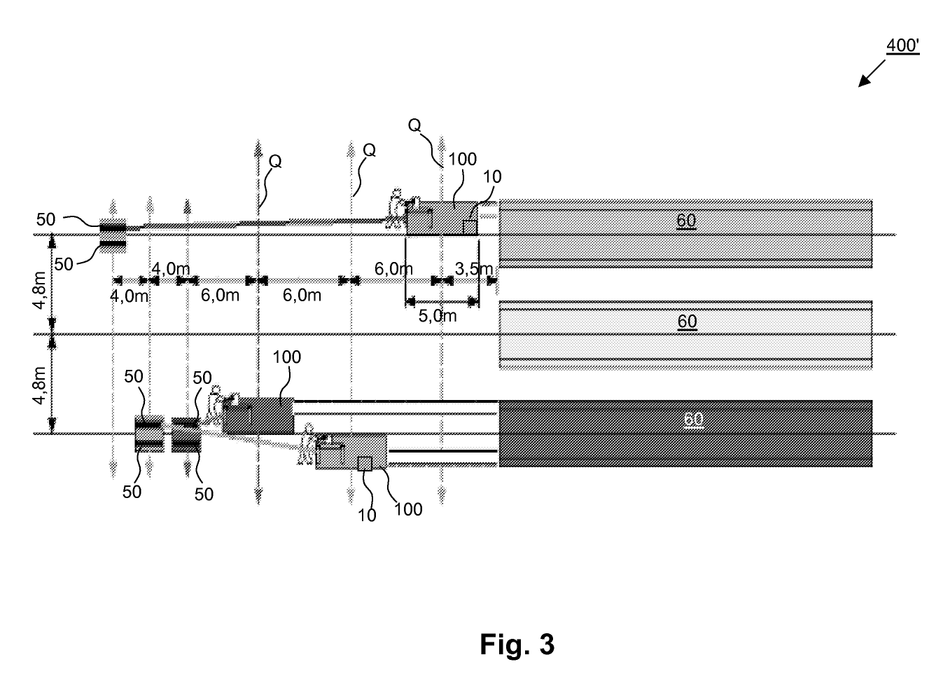

but also to the exemplary embodiment of a device 400′ according to the present invention, as shown in FIG. 3

as well as to the exemplary embodiment of the connection arrangement of the electrical conductor 40 according to the present invention, as shown in FIG. 6

as well as to the exemplary embodiment of the connection arrangement of the electrical conductor 40 according to the present invention, as shown in FIGS. 7A, 7B, 7C, 7D

as well as to the exemplary embodiment, shown in FIG. 8, of a girder comprising the electrical conductors shown in FIG. 7A

as well as to the exemplary embodiment, shown in FIG. 9, of a method according to the present invention, according to which method the control system of the processing device shown in FIG. 1 operates

FIG. 5A a perspective aspect, obliquely from above, of two stator packets connected according to prior art;

FIG. 5B a diagrammatic top view of the transition region of the two stator packets shown in FIG. 5A;

FIG. 5C a diagrammatic lateral view of the transition region shown in FIG. 5B;

FIG. 5D a diagrammatic cross sectional view of one of the stator packets shown in FIG. 5A;

FIG. 6 a diagrammatic view of a first exemplary embodiment of a connection arrangement of the sections of the electrical conductor according to the present invention;

FIG. 7A a diagrammatic view of a second exemplary embodiment of a connection arrangement of the electrical conductor according to the present invention, at a first girder transition;

FIG. 7B a diagrammatic view of the connection arrangement of the electrical conductor of FIG. 7A, at a second girder transition;

FIG. 7C a diagrammatic view of the connection arrangement of the electrical conductor shown in FIG. 7A, at a third girder transition;

FIG. 7D a diagrammatic view of the connection arrangement of the electrical conductor shown in FIG. 7A, at a fourth girder transition;

FIG. 8 a diagrammatic cross sectional view of the girder shown in FIG. 7A;

FIG. 9 a diagrammatic flow chart relating to a method designed according to the present invention, according to which method the control system of the processing device shown in FIG. 1 operates;

FIG. 10 a diagrammatic bottom view of a girder comprising two long stator windings LSW formed according to prior art;

FIG. 11 a diagrammatic bottom view of an exemplary embodiment of a girder comprising two long stator windings LSW formed according to the method of the present invention;

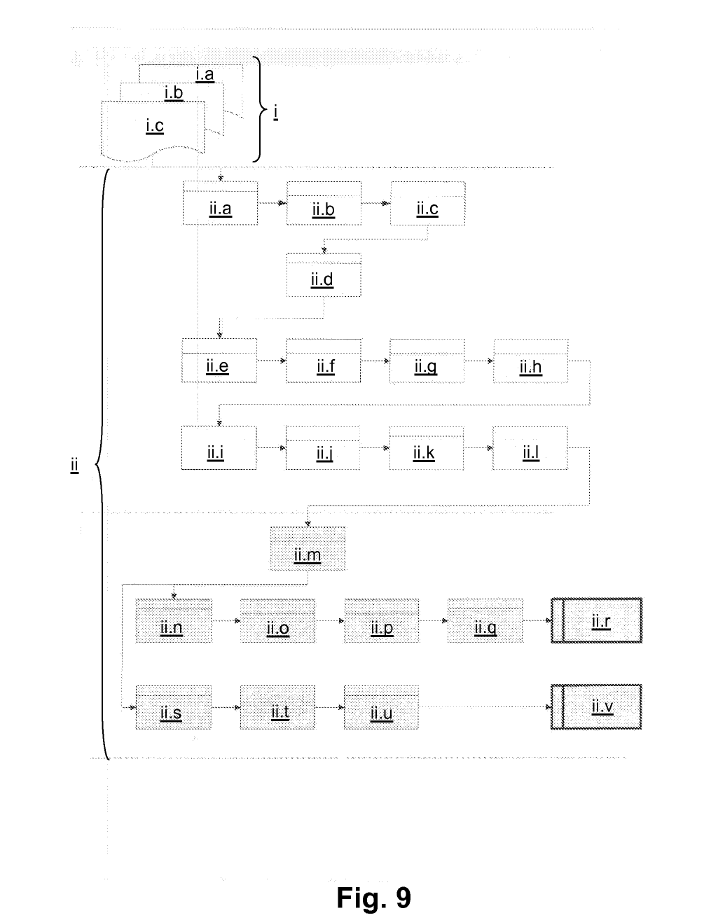

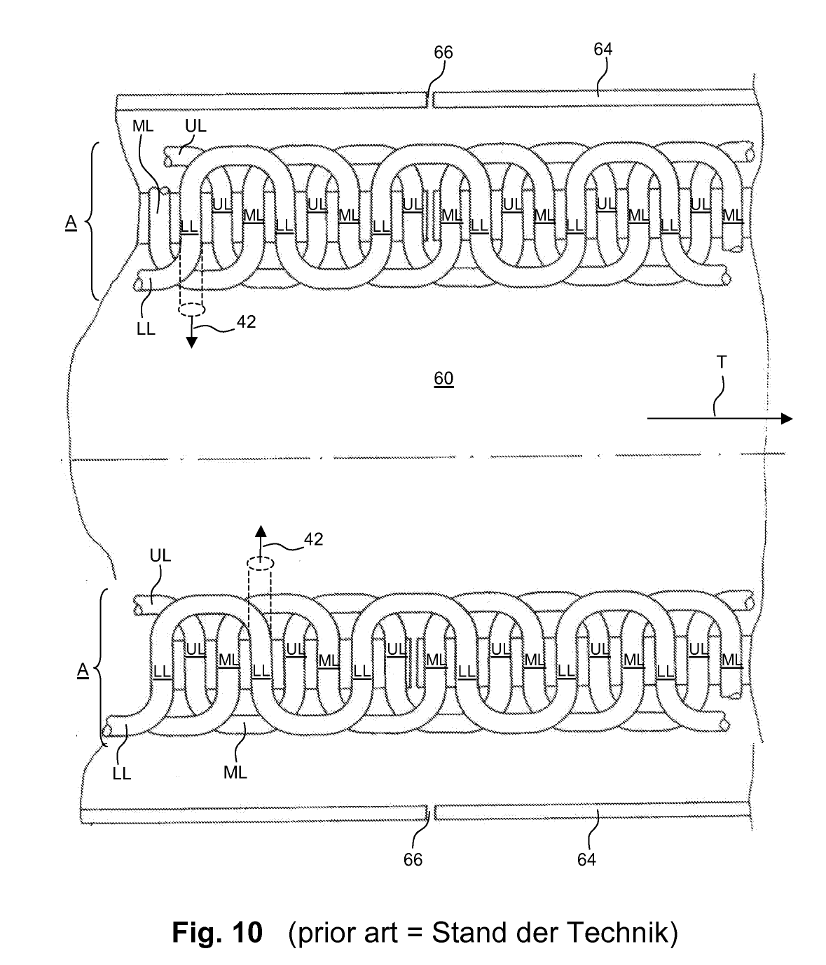

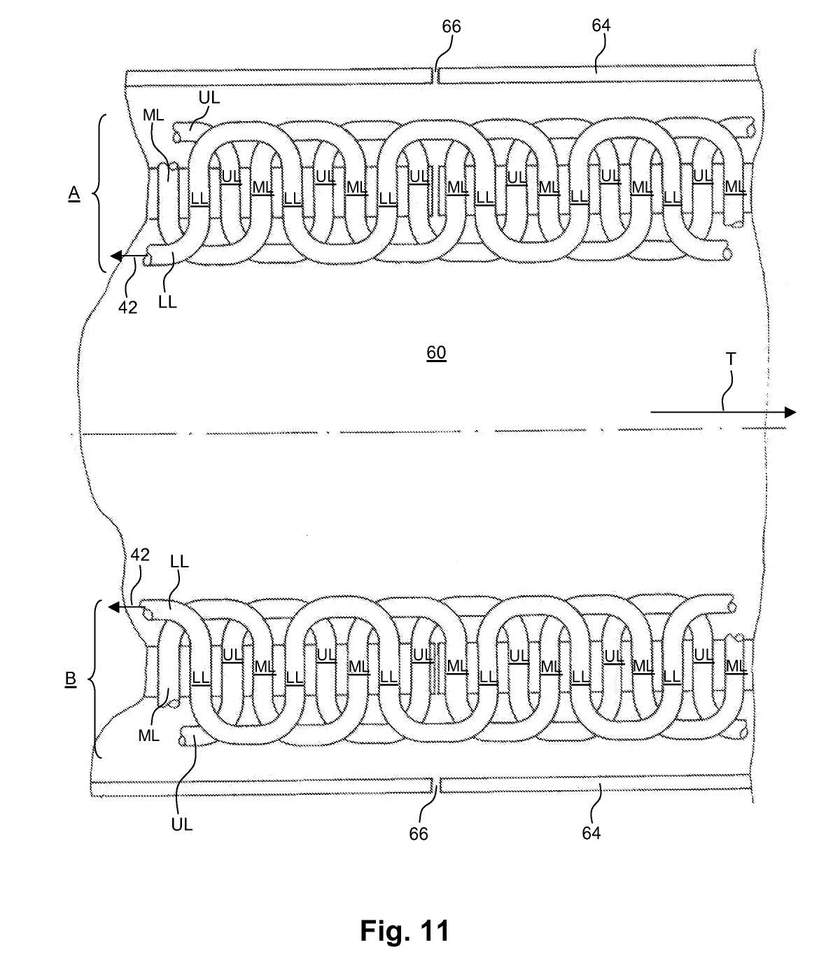

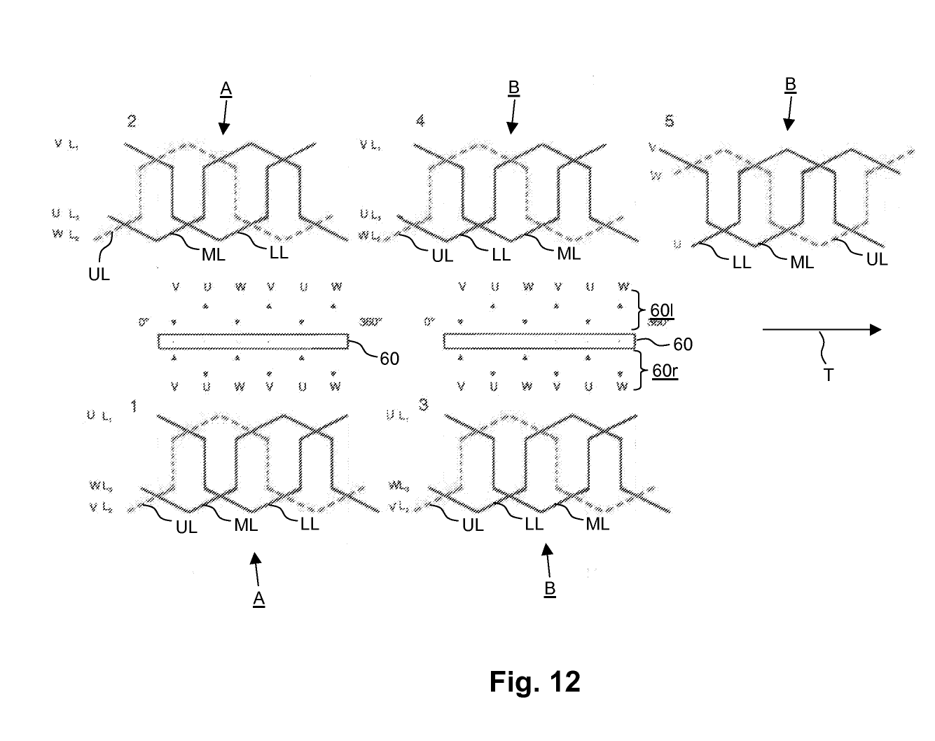

as well as to the exemplary embodiment, shown in FIGS. 11 and 12, of the electrical conductor 40 according to the present invention

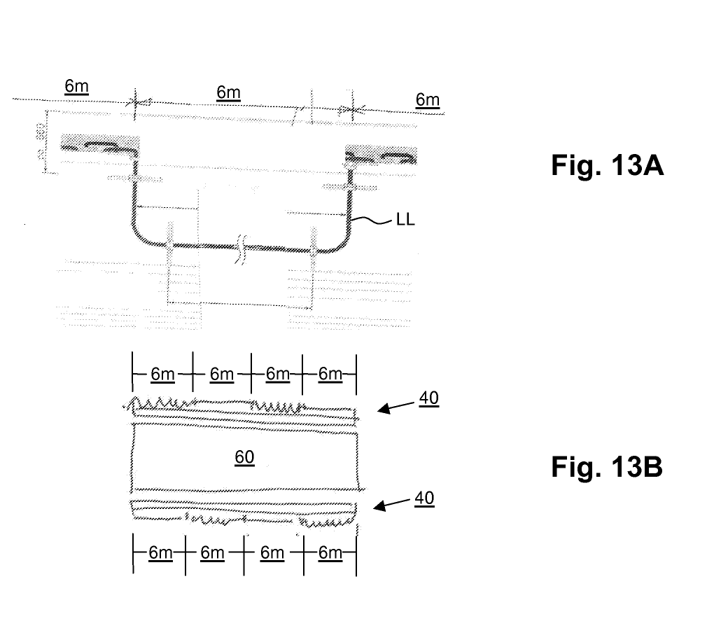

as well as to the exemplary embodiment, shown in FIGS. 13A and 13B, of a girder comprising the electrical conductors shown in FIG. 11.

The information relating to dimensions, which information is shown in FIGS. 1 to 13B, only serves to reproduce the size relationships by way of examples.

The first exemplary embodiment of the present invention, illustrated by means of FIGS. 1 and 2, shows a device 400, in particular an installation device, which operates according to the method according to the present invention and comprises several functional components, namely

an exemplary embodiment of a processing device 100, namely a single-phase or three-phase bending- and crimping device,

an exemplary embodiment of a receiving device 200, namely a belt conveyor, and

an exemplary embodiment of an outfitting device 300, in particular of a laying unit, namely an impression device.

The device 400 comprises a total of three bending- and crimping devices 300, wherein these bending- and crimping devices 100 are designed to pull off in a regulated manner an electrical conductor that is to be processed, namely a long stator winding (LSW) cable 40, from a source 50 of supply, namely from a cable drum, and to form said electrical conductor, in a bending- and crimping process, according to the specifications of a computer-assisted integrated management system (IMS).

At least one of the laying units or impression devices 300 is associated with each of the bending- and crimping units 100.

As an alternative or in addition to this, at least one of the bending- and crimping devices 100 is associated with each laying unit or impression device 300.

Furthermore, an embodiment of the belt conveyor 200 as a narrow conveyor with lamella is possible, wherein this rubber belt conveyor preferably conveys the motor winding in its head-down position or in alignment with the girder 60.

In this arrangement the belt conveyor, concurrently with the rotary movement of the belt, can carry out a rearward translatory movement.

Furthermore, it is possible for an impression wheel or an impression device to move from some other direction to the stator surface.

Another possible embodiment of the receiving device 200—for reasons of clarity not shown in the diagrams—comprises a suspension device with transverse pendulum suspension devices that are spaced apart from each other at defined spacings.

The electrical conductor can be equidistantly held by these pendulum suspension devices by means of two straps, wherein these straps can optionally be cut off after the electrical conductor 40 has been laid.

The impression device 300 is designed to outfit the girder 60 with the long stator winding (LSW) cable 40.

The second exemplary embodiment of the device 400′, which embodiment is shown in FIG. 3, differs from the first exemplary embodiment 400 that is shown in FIGS. 1 and 2 in that the cable drums 50 are arranged decentrally, namely on the side facing away from the girder 60, of the respective bending- and crimping device 100. In line with the direction of movement (reference character Q) of the bending- and crimping devices 100, the cable drums 50 are also movable, in particular traversable.

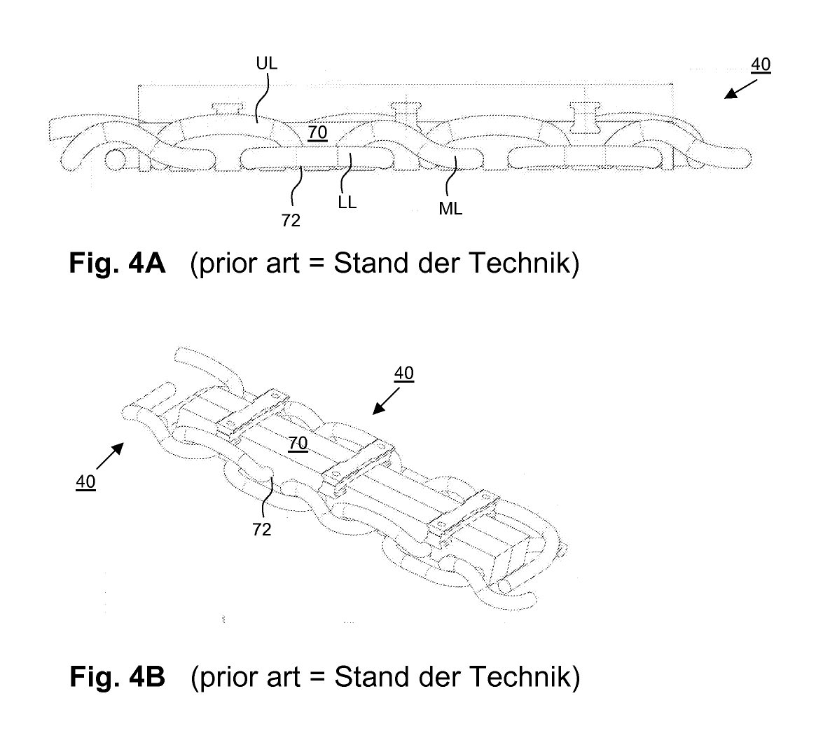

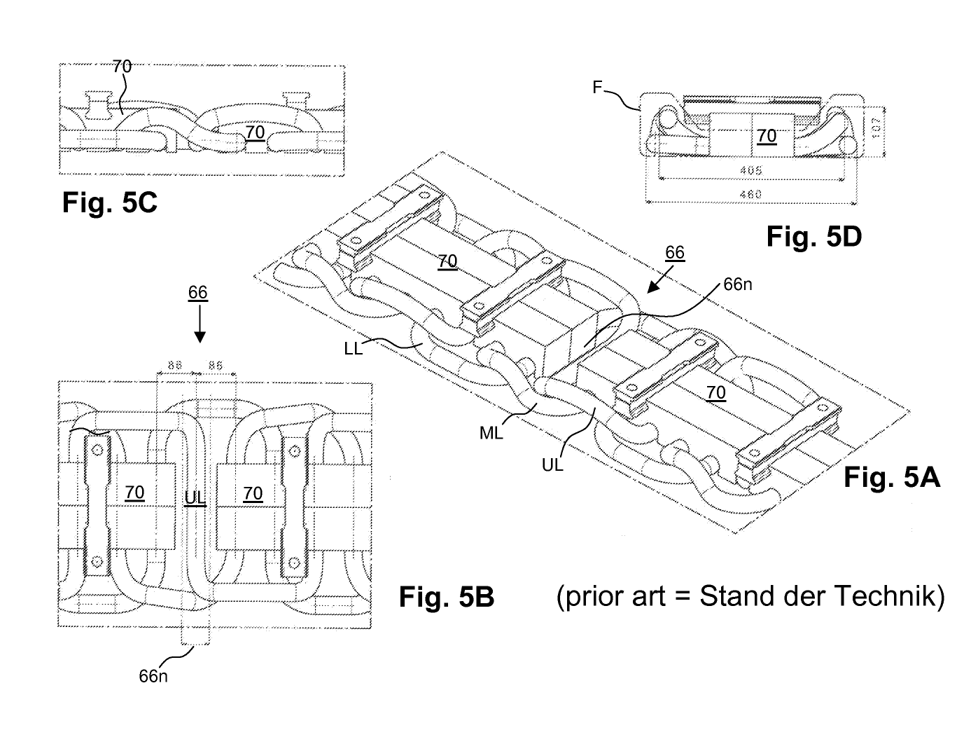

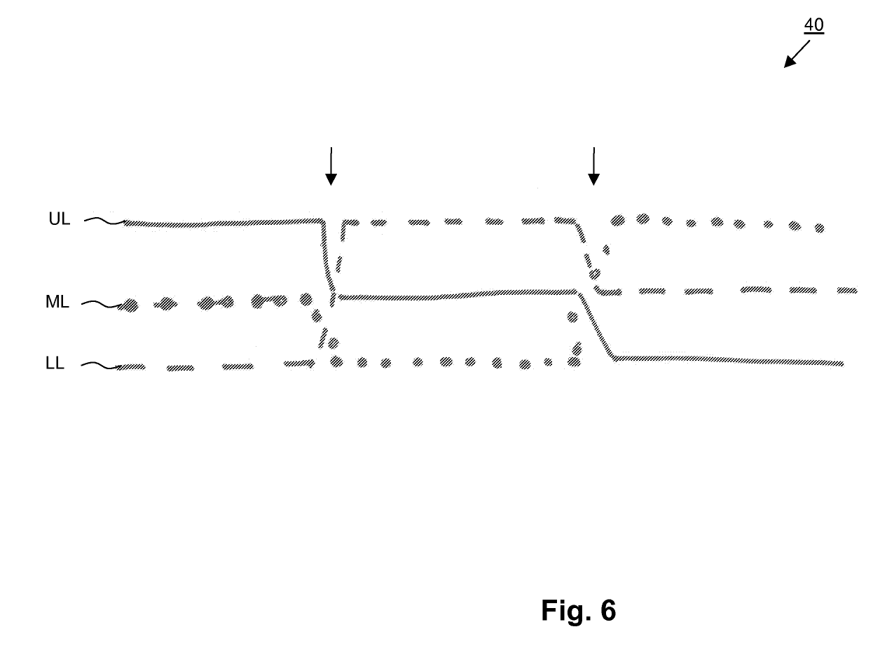

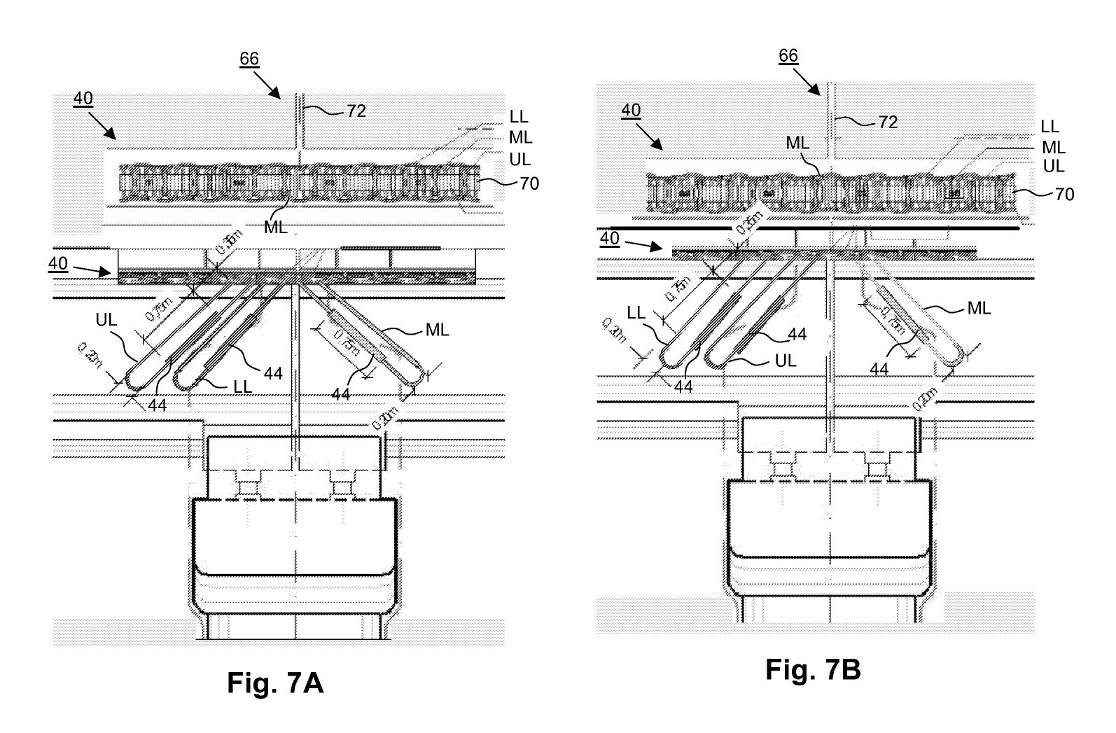

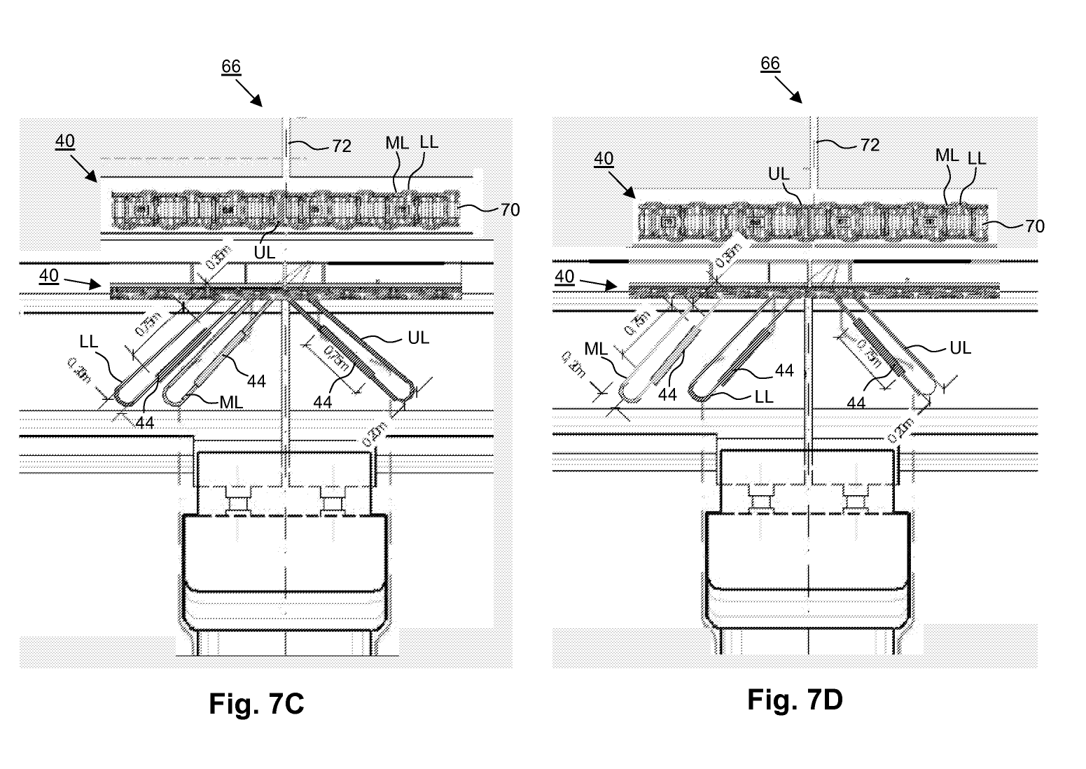

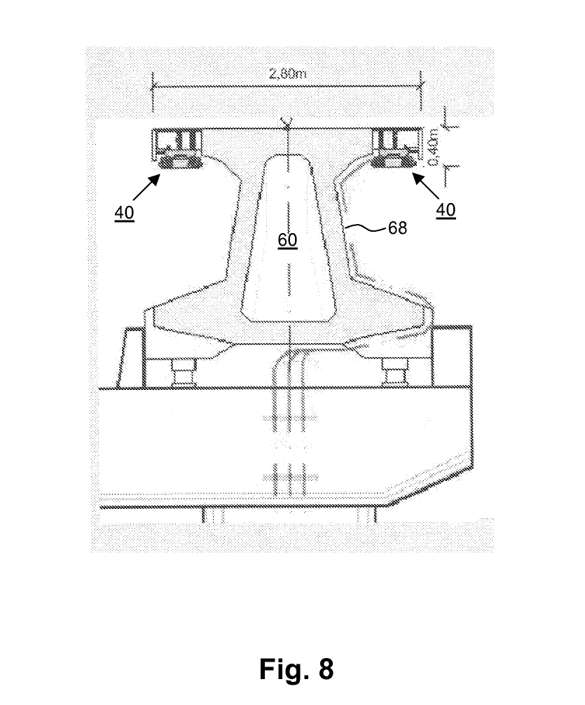

FIG. 4A shows a diagrammatic lateral view of a stator packet 70 with three-phase windings 40 for a linear motor according to prior art.

A stator packet of a long stator corresponds to the stator of a hinged-open three-phase electrical synchronous motor, into whose grooves 72 the three-phase windings 40 are placed. In this arrangement the three-phase windings 40 comprise three trains of windings, namely a lower layer LL, a middle layer ML and an upper layer UL.

At least one of the bending- and crimping units 100 forms a bending-, crimping- and laying unit (BKV) with at least one of the impression devices 300 and optionally with the belt conveyors 200.

In this arrangement, as shown in FIGS. 1 and 3, a girder 60 can be outfitted with the LSW cable 40

by means of a bending-, crimping- and laying unit (BKV), or

by means of two bending-, crimping and laying units (BKVs).

In the first exemplary embodiment of the device 400, shown in FIGS. 1 and 2, two cable drums 50 are associated with each bending- and crimping device 100, wherein the cable drums 50 are arranged above the bending- and crimping devices 100.

The bending- and crimping devices 100 comprise wheels 110 so that they can be moved on rails 120 associated with the respective bending- and crimping devices 100.

The direction of movement (reference character Q) of the bending- and crimping devices 100 is essentially perpendicular in relation to the longitudinal axis 62 of a girder 60 that is associated with the respective bending- and crimping device 100 and that is to be outfitted with the LSW cable 40, namely of a stator of a linear motor, specifically a travel way girder, such as for instance a steel girder, concrete girder or hybrid girder, of a magnetic levitation train.

The belt conveyor 200 is designed to convey the LSW cable 40, which has been provided and formed by the bending- and crimping device 100, to the desired point of installation on the girder 60. To this effect the belt conveyor is movable essentially along (reference character L) the direction of the longitudinal axis 62 of the girder 60 to be outfitted.

Advantageously the belt conveyor 200 can be a heavy rubber belt conveyor with lamellae and can convey the motor winding in its position of use. In this arrangement the lamellar distance is expediently approximately half a pole pitch, as a result of which after receiving the first meandering shape, the following meandering shapes are provisionally fixed with the same spacing.

FIG. 4B shows a perspective aspect of the stator packet 70 that comprises twelve grooves into which the respective trains of windings LL, ML, UL of the motor winding 40 have been impressed. FIG. 4B also shows the stator assignment of a standard stator packet, comprising twelve grooves, with two three-phase windings 40.

FIGS. 5A, 5B, 5C, 5D show an exemplary embodiment of a linear motor equipped with a long stator winding LSW according to prior art, wherein in particular the transition between two stator packets 70 is shown.

As shown in FIGS. 5A and 5B, the upper train of windings UL at the girder abutment or girder transition 66 is located in a so-called free groove 66n.

The dimensions stated in FIG. 5D in relation to the long stator winding LSW are exemplary standard values, wherein deviations within the gap delimitation F are permissible.

The electrical conductor 40 according to prior art, which conductor 40 is arranged on the girder 60, in particular the long stator winding or excitation winding arranged in the grooves 72 of the stator packet 70, is spatially designed such that the distance between the individual phases OL, ML, UL and the core of the stator 60 differs.

The above is due to the physical necessity of leading the windings of each phase

OL, ML, UL past each other; thus the individual trains of windings OL, ML, UL are arranged in different spatial positions in relation to each other.

As a result, different current fields are generated in the individual phases OL, ML, UL of the linear motor, in particular of the synchronous linear motor.

According to prior art, during the outfitting of the girder 60 with the electrical conductor 40, always the upper layer UL, which is also referred to as phase 3, is laid first. Furthermore, according to prior art the following are laid:

in a second laying step always the middle layer ML, which is also referred to as phase 2, and

in a third laying step always the lower layer LL, which is also referred to as phase 1.

Thus, according to prior art the installation sequence is as follows:

upper train of windings UL,

middle train of windings ML,

lower train of windings LL.

In contrast to prior art, in the case of the present invention, as shown in FIG. 6, any planned change of the phases LL, ML, UL can be carried out.

This phase change basically involves physical separation of the three winding phases LL, ML, UL of the electrical conductor 40, and subsequent crossover connection of these phases LL, ML, UL.

To this effect, after completion of the forming process and/or after completion of attaching the electrical conductor 40 to the girder 60 and/or in the girder 60, in particular at the transition 66 (compare FIG. 11) of a unit or of a section of the girder 60, the electrical conductor 40 is subdivided into sections.

For example, during the joining of two girder units, each comprising a section of the electrical conductor 40, the respective phases LL, ML, UL of the sections of the electrical conductor 40 are connected, in particular interconnected or interlinked, for example by means of sleeves, wherein at least two of the respective phases LL, ML, UL of the sections of the electrical conductor 40 are connected so as to alternate or be transposed, in particularly crossed over.

The first physical winding layer that has been laid or impressed in the girder 60 is thus, for example, electrically formed by:

the electrical third phase UL, for example for a third of any desired girder section, at least however for a girder length;

the electrical second phase ML or the electrical first phase LL, for example for the second third of any desired girder section, at least however for a girder length; and

the electrical first phase LL or the electrical second phase ML, for example for the third third of any desired girder section, at least however for a girder length.

For example, the first laid upper layer UL in the first third of any desired long stator winding LSW section can thus be the electrical third phase UL, and it can be situated at a planned girder transition 66.

In the second third of any desired long stator winding LSW section, the first laid upper layer UL can be the electrical second phase ML or the electrical first phase LL, and it can be situated at a planned girder transition 66.

The first laid layer UL in the third third of any desired long stator winding LSW section can be the electrical first phase LL or the electrical second phase ML, and it can be situated at a planned girder transition 66.

Connection of the laid or produced trains of windings LL, ML, UL (compare FIG. 6) takes place accordingly. The connection locations, in other words the positions at which the phases LL, ML, UL are separated and comprise sleeves are shown in FIG. 6 by a respective arrow.

A further preferred variant, which for reasons of clarity is not shown in the diagrams, involves a change of the respective layer UL (=upper layer) to ML (=middle layer), ML to LL (=lower layer) and LL to UL after a third of the motor section and the original UL to

LL, the original ML to UL and the original LL to ML after a further third of the motor section, in each instance at planned girder transitions 66.

By means of connecting the phases LL, ML, UL the above-described irregular current fields of the three individual phases are evened out, because all the phases are laid within a motor section of the long stator winding of the linear motor at a third each of the section lengths in the layer UL, in the layer ML and in the layer LL.

The present invention thus makes possible any desired planned change of the layers of the phases OL, ML, UL without any additional expenditure. By means of such displacements, asymmetries of a three-phase synchronous linear motor are evened out.

By means of sectionally subdividing the electrical conductor 40, in particular by separating the three-phase LSW cable, which separating is, for example, carried out at each girder transition 66, it is possible to carry out the production and laying of the trains of windings of the linear motor in a hall.

Furthermore, by sectionally subdividing the electrical conductor 40, in particular by individual girder installation, a situation is achieved where the electrical conductor 40, according to the present invention (compare for example FIG. 11) is not routed through an extension gap 66n in the free space, as is the case in prior art (compare FIGS. 5A and 5B).

In conjunction with sectional subdivision, the present invention proposes a particularly advantageous design of sleeve attachment and its arrangement in a new way (compare FIGS. 7A, 7B, 7C, 7D).

FIG. 7A shows an example of a connection arrangement on a first girder transition 66 of a linear motor of one hundred per cent drive, wherein the connection of the electrical conductors 40 of the respective girder units in the second phase ML extends in a groove 72 of the girder 60 from the outside of the girder towards the inside of the girder.

In the longitudinal view according to FIG. 7A the second phase ML at the girder transition 66 thus extends in an S-shape in the groove 72, wherein the groove 72 can be a free groove or it can be encased by the girder 60.

FIG. 7B shows an example of a connection on a second girder transition 66 of the linear motor, wherein the connection of the electrical conductors 40 of the respective girder units in the second phase ML extends in a groove 72 of the girder 60 the other way round when compared to FIG. 7A, namely from the inside of the girder towards the outside of the girder.

Thus in the longitudinal view according to FIG. 7B the second phase ML at the girder transition 66 extends in the groove 72 in a mirror image in relation to the second phase ML as shown in FIG. 7A, wherein the imaginary mirror axis corresponds to the alignment of the groove 72; wherein, again, the groove 72 can be a free groove or it can be encased by the girder 60.

FIG. 7C shows an example of a connection on a third girder transition 66 of the linear motor, wherein the connection of the electrical conductors 40 of the respective girder units in the third phase UL extends in a groove 72 of the girder 60 from the outside of the girder towards the inside of the girder.

In the longitudinal view according to FIG. 7C the third phase UL at the girder transition 66 thus extends in an S-shape in the groove 72; wherein the groove 72 can be a free groove or it can be encased by the girder 60.

FIG. 7D shows an example of a connection on a fourth girder transition 66 of the linear motor, wherein the connection of the electrical conductors 40 of the respective girder units in the third phase UL extends in a groove 72 of the girder 60, the other way round when compared to FIG. 7C, namely from the inside of the girder towards the outside of the girder.

Thus in the longitudinal view according to FIG. 7D the third phase UL at the girder transition 66 extends in the groove 72 in a mirror image in relation to the third phase UL as shown in FIG. 7C, wherein the imaginary mirror axis corresponds to the alignment of the groove 72; wherein, again, the groove 72 can be a free groove or it can be encased by the girder 60.

Each of the three phases LL, ML, UL comprises a connection means, in particular an interconnection element or an interlinking element, namely a sleeve 44, wherein this sleeve 44 can extend for example along a length of approximately 75 centimetres of the respective phase LL, ML, UL of the electrical conductor 40.

Each of the elongated loops, shown in FIGS. 7A, 7B, 7C 7D, of the three phases LL, ML, UL, can for example be approximately 20 centimetres in diameter and is advantageously reinforced at its respective bend, for example by means of a further sleeve.

FIG. 8 shows a cross section of the girder 60 from FIG. 7A, which girder 60 comprises two electrical conductors 40 that have been wound according to the present invention, wherein the sectional plane in FIG. 7A is indicated by the dashed line S.

Optionally, the processing device 100 comprises at least one control system 10, in particular at least one computer-assisted integrated management system IMS (compare FIGS. 1, 2, 3).

In order to acquire data and/or information that are/is relevant to processing the electrical conductor 40, the IMS 10 can comprise at least one detector unit, in particular it can comprise at least one measuring device and/or at least one sensor. Production and installation of the trains of windings 40 of the linear motor can thus be automated by means of the IMS 10.

Advantageously, for each girder 60 the IMS 10 calculates the windings pattern of the electrical conductor 40 as well as the respective connection point; for example, the IMS 10 calculates on which girder 60 the new connection, in particular the phase change, is to take place.

Up to the phase change, the windings pattern within an LSW section of the LSW cable 40 is identical for each girder 60. Preferably, the LSW cable 40 that is arranged on the opposite side of the girder 60 has a different windings pattern, wherein the phase change, too, can be provided at some other point. The motor sections can thus be arranged on each side of the carriageway of the girder 60 so as to be offset in relation to each other.

Expediently, for each girder 60, on both LSW sides, the IMS 10 automatically calculates the windings pattern, determines the machine data for producing the individual trains of windings, and determines the data for placement of the trains of windings into the stator grooves 72.

Moreover, the IMS 10 preferably determines the position of all the connections required for connecting the long stator windings LSW 40 and other equipment modules of the particular girder 60, for example position reference strips and/or current rails.

The computer-assisted integral management system (IMS) 10 is preferably arranged in the bending- and crimping device (SBK) 100. Assignment of the IMS 10 to the modules of the device 400, 400′, in particular the planning process carried out in the IMS 10, is shown in FIG. 9.

As a basis for planning (reference character i in FIG. 9), system documents i.a and/or at least one line layout guideline i.b and/or at least one set of drive specifications i.c are used.

Supported by this basis for planning i, the IMS 10 carries out data calculation and data processing (reference character ii in FIG. 9).

In this arrangement, in a first step ii.a the line layout of the transrapid line is determined, in particular the line layout of a track A (step ii.b in FIG. 9) up to the line layout for both tracks, i.e. for the left-hand side and the right-hand side, of the girder 60 (step ii.c in FIG. 9).

After this a catalogue relating to the outfitting of the travel way is prepared (step ii.d in FIG. 9). By means of this catalogue the spacing of the supports (step ii.e in FIG. 9), the spacing of the girders 60 (step ii.f in FIG. 9), the spacing of the modules (step ii.g in FIG. 9) and the spacing of the stator packets (step ii.h in FIG. 9) of the girder 60 are determined.

Thereafter, the offset of the motor winding of the opposite carriageway sides of the girder 60, i.e. of the left-hand side and of the right-hand side of the travel way girder, is calculated (step ii.i in FIG. 9).

Furthermore, the coefficient of the drive period (step ii.j in FIG. 9), the position of the position reference strips (step ii.k in FIG. 9) and the type of connection, in particular the phase change, of the motor winding in relation to the left-hand side and in relation to the right-hand side of the travel way girder 60 (step ii.l in FIG. 9) are determined.

The data and information determined as mentioned above are processed as machine data for the bending- and crimping device 100 as well as for the outfitting device 300 (step ii.m in FIG. 9).

In particular, processing of the data and information takes place to determine

the spacing of the tracks in motor sections (step ii.n in FIG. 9),

the spacing of the motor sections in long stator phases LSPs (step ii.o in FIG. 9),

the number of meandering shapes for each respective phase (step ii.p in FIG. 9), and

the number of meandering shapes for each respective girder 60, in each case in relation to the left-hand side of the carriageway and to the right-hand side of the carriageway (step ii.q in FIG. 9).

This processed data and information is thus used as machine data in producing the meandering shapes (step ii.r in FIG. 9).

Furthermore, processing of the machine data determined in the step ii.m is used to determine

the groove assignments at the girder transition 66 (step ii.s in FIG. 9),

the respective phase connection arrangement and the respective connection pattern of the girders 60 (step ii.t in FIG. 9), as well as

the remaining connection patterns, in particular non-phase-connected connection patterns in relation to the respective girder 60 (step ii.u in FIG. 9).

This processed data is thus used as machine data for laying the meandering shapes in the girder 60 (step ii.v in FIG. 9).

The present invention is associated with an advantage in that the process parameters during production and laying of the trains of windings can be held so as to be constant, in particular in that the process parameters during the production of the electrical conductor 40 as well as during the outfitting of the girders 60 can be controlled with the electrical conductor 40.

To this effect the production device or processing device 100 can be controlled by at least one central control unit and/or by at least one central computer.

The central computer can take the machine data over from the IMS 10. The IMS 10 is thus in a position, from the system-specific data and information, to calculate all the data and information required for producing and laying the electrical conductor 40, and to convey this data and information to the central control unit as machine data and machine information; wherein, for example, the number of the meandering shapes and the length of the straight line is part of such data or information.

Taking over data and information provided by the IMS 10 is, for example, used for controlling a cable take-off device of the production device or processing device 100. In this way it is, in particular, possible to control the take-off movement of the cable drum by means of at least one servo motor.

Furthermore, for the purpose of controlling the cable take-off device, the cable use can be determined, for example by means of at least one measuring device. Moreover, it is possible, for the purpose of controlling the cable take-off device, to determine the remaining length of the supply and the point in time at which a drum change will be required.

By means of the machine data and machine information taken over from the IMS 10, furthermore, the bending- and crimping device 100 can be controlled. Controllable are in particular

the movement sequence and the closing of the bending jaws,

the movement sequence and the closing of the crimping jaws,

the transfer movement of the meandering shapes up to the receiving device 200,

the production of a precise number of meandering shapes in a defined phase,

the supply of connection lengths depending on the respective type of girder, for example depending on the respective girder length, and/or depending on the respective type of connection,

the bending parameters, for example the dwell time in the bending jaws, and/or the contact pressure, and/or

the crimping parameters, for example the dwell time in the crimping jaws, and/or the crimping height.

Furthermore, according to an advantageous embodiment of the present invention, due to the arrangement of the functional units 100, 200, 300 of the device 400, the process parameters can also be kept constant in a closed or at least partly roofed-over building.

This not only provides the advantage of independence from the weather, in particular independence from wind, rain, but also from lighting conditions.

Constant process temperature, in particular constant ambient temperature in the girder outfitting hall, and the use of a preheated line drum have an influence, for example, on the stiffness of the electrical conductor 40, in particular on

forces when drawing the line 40 from the source of supply 50,

bending forces in the bending/crimping process,

restoring forces and/or the ability of the electrical line 40 to keep its shape in the bending/crimping process,

the process speed, and/or

the force required when pressing the electrical conductor 40 into the girder 60.

Furthermore, the environment of a hall provides advantages such as for instance short paths and fast availability of materials, equipment and personnel.

It is thus possible to increase productivity, in particular

by using (semi-)automated integration of the outfitting components,

by improving quality,

by constant production conditions and/or

by the use of control devices or monitoring devices, for example of auxiliary devices and/or projectors, such as for instance projectors for projecting connection images and assignment images of the outfitting components directly onto the work piece, for example onto the girder 60.

FIG. 10 shows a bottom view of a girder 60 comprising two electrical conductors wound according to prior art, namely two long stator winding (LSW) cables 40 wound according to a first type A of windings.

The travel way 60 comprises two girder units, wherein the girder transition 66 is diagrammatically shown in FIG. 10. The line layout T of the travel way girder 60 takes place in opposite direction of the connections 42 of the travel way girder 60.

In the LSW cable 40 shown in the top half of FIG. 10, which cable in relation to the direction T of the line layout is arranged on the left-hand side of the girder 60, the meandering shape of the lower layer LL points towards the girder 60 and can be connected to the girder 60.

In contrast to the above, in the case of the LSW cable 40, which in relation to the direction T of the line layout is arranged on the right-hand side of the girder 60, the meandering shape of the lower layer LL points away from the girder 60 and cannot be connected to the cheeks of the girder.

Instead, with corresponding effort and corresponding loss of quality, the pre-bent meandering shapes first have to be de-formed or bent towards the connection of the girder 60. For this reason free grooves without drive remain at the connection points, in other words grooves without any trains of windings laid into them. Such free grooves are tantamount to a gap in the drive for the magnetic levitation vehicle.

FIG. 10 thus shows prior art with the same windings pattern on the left-hand LSW side of the girder 60 and on the right-hand LSW side of the girder 60.

In contrast to this, according to the present invention the girder 60 advantageously comprises

an LSW cable 40 wound according to a first type A of windings, and

an LSW cable 40 wound according to a second type B of windings.

FIG. 11 shows a bottom view of a girder 60 comprising

an LSW cable 40 wound according to a first type A of windings, and

an LSW cable 40 wound according to a second type B of windings,

wherein the windings patterns of type A windings and type B windings are mirror-symmetrical.

Both in type A windings and in type B windings the upper layer UL points towards the girder 60 and can be connected, as shown in FIG. 11 by means of an arrow 42. The respective ends of the upper layer UL are thus situated on the side of the girder 60, which side faces away from the travel way, for example from the slab travel way.

This first type of windings (<-->reference character A) and this second type of windings (<-->reference character B) are shown in more detail in FIG. 12.

In this arrangement the connection positions of the LSW cables 40 are designated with the reference characters U, V and W. The LSW cables 40, designated 1 or 2, are formed according to type A windings, while the LSW cables 40 designated 3, 4 or 5 are formed according to type B windings.

The middle half of FIG. 12 shows a diagrammatic top view of a girder 60 comprising an LSW cable 40 arranged on the left-hand side 601 of the travel way and on the right-hand side 60r of the travel way.

The production or implementation of types A and B of windings according to trans-rapid specifications may be required for projects. In contrast to technologies according to prior art, in an advantageous embodiment of the present invention this can be implemented without increased logistics expenditure.

If in the outfitting of a girder 60 one of the bending- and crimping devices 100 is used, this bending- and crimping device 100 is advantageously designed for forming the electrical conductor 40 according to both type A windings and type B windings.

In contrast to the present invention, according to prior art if a (universal) bending- and crimping device, in particular a BKV, is used that is designed both for forming the electrical conductor 40 according to type A windings and for forming the electrical conductor 40 according to type B windings, depending on the direction of extension in the girder 60, only one of the two types A or B of windings can be implemented.

As described above, this can be associated with a disadvantage in that the direction of windings on the girder transition on one side leads towards the girder 60, while on the opposite side it leads away from the girder 60.

In relation to the meandering shapes that lead from the girder 60 towards the outside, this is associated with a disadvantage in that the meandering shapes have to be manually de-formed in order to be connected on the girder 60 or to the girder 60, and in that the stator 60 is not completely assigned, in particular in the form of a missing groove assignment. These disadvantages do not apply if the two types A and B of windings are implemented, as shown in FIG. 11.

If two bending- and crimping devices 100, in particular two bending-, crimping- and laying units (BKVs), are used for outfitting one of the girders 60 (compare FIG. 3), according to an advantageous embodiment of the present invention one of the two bending- and crimping devices 100, in particular of the two BKVs, is designed for forming the electrical conductor 40 according to the type of windings A while the other bending- and crimping device 100, in particular the further BKV, is designed for forming the electrical conductor 40 according to the type of windings B.

By means of the present invention it is thus possible to eliminate the above-described disadvantages associated with prior art by using two bending- and crimping devices 100, each of which is specialist to one type of windings, in particular by using a bending-, crimping- and laying unit for type A windings, and the other bending-, crimping- and laying unit for type B windings.

The use of bending- and crimping devices 100 that are specialised to one type of windings is in particular advantageous in the case of stationary bending- and crimping devices 100, i.e. in particular if all the functional units 100, 200, 300 of the device 400 are accommodated in a closed building or at least in a building comprising a roof, namely in a hall, specifically in a girder outfitting hall. For example, FIGS. 1, 2, 3 show laying of the LSW cable 40 in the girder outfitting hall.

In a mobile device according to prior art, the use of bending- and crimping devices 100 that are specialised to types A and B of windings, in other words where laying the LSW cable 40 takes place on the construction site, is considerably more expensive as a result of the accommodation situation and the machinery size under construction site conditions, which is why in such a case the investment costs for providing laying trains multiply.

When compared to the investment costs for specialised bending- and crimping devices 100 of a device 400 or 400′ in an enclosed building, or at least in a roofed building, this is also uneconomical.

In order to provide reduced drive output of the linear motor, the electrical conductor 40 can be non-formed in sections, in particular it can be provided so as to be non-wound over a corresponding pro-rata length, as shown in FIGS. 13A and 13B.

For reasons of clarity, in FIG. 13A the region without windings is only shown in the case of the lower layer or the first phase LL. However, the depiction of the region without windings applies to all layers LL, ML, UL of the electrical conductor 40.

The percentage of the drive output can be designed individually. In order to provide a drive with fifty per cent drive output the electrical conductor 40, for example, comprises alternate sections each six metres in length (=6 m in FIGS. 13A and 13B) of wound line, and six metres in length (=6 m in FIGS. 13A and 13B) of straight line.

In this arrangement, as shown in FIG. 13B by the example of a girder 60 24 metres (=four times 6 m in FIG. 13B) in length, the windings patterns, in particular the formed regions and the non-formed regions, of the long stators 40 arranged on opposite sides of the carriage-way, are preferably arranged so as to be offset in relation to each other.

In order to provide a drive with sixty per cent drive output, for example nine metres of windings alternate with six metres of straight line; while in order to provide a drive with 66 per cent drive output, for example twelve metres of windings alternate with six metres of straight line.

The straight length of a period of windings of the electrical conductor 40 is preferably identical in all three trains of windings LL, ML, UL; in the case of a line that is through-wound it is for example 1,212.6 millimetres. Advantageously a winding period corresponds to approximately six stator groove spacings; it measures for example 516 millimetres.

When compared to a line that is through-wound for providing the full drive output, less material is used for the electrical conductor 40 in the case of providing reduced drive out-put.

For example, in the case of halved drive output the straight length of the windings in a metre of travel way length is two periods, namely 2.4 metres of line. Material savings in the case of a straight line are thus approximately 60 per cent, namely 1 to 2.4.

Thus, in the case of reduced drive output, the winding factor, in other words the ratio of straight length of the electrical conductor 40 for a winding period to the travel way length, is approximately 2.4.

The length-related mass of the travelling-field line of a through-wound electrical conductor 40 is for example 1.84 kilogram per metre. Deviations in the form and/or in the position are permissible up to a size in which

the gap delimitation F (compare FIG. 5D) is not exceeded, and

the correct geometric constellation of the trains of windings among themselves is maintained.

For the sake of clarity, earth sleeves and earth lines are not shown in the diagrams.

In a nutshell, FIGS. 1 to 13B show the high-quality flexible outfitting of the long stator windings of a magnetic levitation train system.

### LIST OF REFERENCE CHARACTERS

10 Control system, in particular integrated management system IMS

40 Electrical conductor, in particular travelling-field conductor, for example train of windings, specifically long stator winding (LSW) cable or long stator

42 Connection of the electrical conductor 40 on the girder 60

44 Connection means, in particular connection element or interlinking element, for example travel way girder or carriageway girder, for instance steel-, concrete- or sleeve of the electrical conductor 40

50 Source of supply, in particular drum, for example cable drum

60 Carrier, in particular stator of a linear motor, for example travel way girder or carriageway girder, for instance steel girder, concrete girder or hybrid girder, of a magnetic levitation train

60l Left-hand side of the girder 60, when viewed in line layout direction

60r Right-hand side of the girder 60, when viewed in line layout direction

62 Longitudinal axis of the girder 60

64 Travel way, in particular slab travel way, of the girder 60

66 Transition between two girder units of the girder 60, in particular girder transition

66n Free groove or expansion gap at the girder transition 66 in prior art (compare FIGS. 5A and 5B)

68 Cheek of the girder 60

70 Stator packet of the girder 60

72 Groove of the girder 60, in particular groove of the stator packet 70

100 Processing device, in particular bending- and crimping device

110 Wheel of the processing device 100

120 Travel way associated with the processing device 100, in particular rail associated with the wheels of the processing device 100

200 Receiving device, in particular conveyor device, for example belt conveyor

300 Outfitting device, in particular laying unit, for example impression device

400 Device, in particular installation device

(=first exemplary embodiment; compare FIGS. 1 and 2)

400′ Device, in particular installation device

(=second exemplary embodiment; compare FIG. 3)

A First type of windings, associated with the electrical conductor 40

B Second type of windings, associated with the electrical conductor 40

F Gap delimitation

L Direction of movement of the receiving device 200

LL First phase, in particular lower train of windings of the electrical conductor 40, for example lower layer of the long stator winding LSW

ML Second phase, in particular middle train of windings of the electrical conductor 40, for example middle layer of the long stator winding

Q Direction of movement of the processing device 100

T Line layout direction of the girder 60, in particular direction of completion of the travel way girder 60

UL Third phase, in particular upper train of windings of the electrical conductor 40, for example upper layer of the long stator winding LSW.

1. A device for processing a travelling-field electrical conductor for a linear motor, wherein said electrical conductor comprises at least one electrical line, such as a train of windings,
characterised in that:
the electrical conductor, by means of the processing device
is made available in a regulated manner from a source of supply comprising a drum, and
is formable in a controlled manner as an alignable, bendable, crimpable or windable long stator winding (LSW).

2. The processing device according to claim 1, including a computer-assisted, control system for selectively acquiring and determining data or information that is relevant to the processing of the electrical conductor.

3. The processing device according to claim 1, wherein the processing device is designed for three-phase winding of the electrical conductor, in particular for winding:
at least one first phase (LL),
at least one second phase (ML), and
at least one third phase (UL),
of a long stator winding (LSW).

4. The processing device according to claim 1, wherein the processing device is designed for sectional forming of the electrical conductor such that in a reduced drive output of the linear motor, the electrical conductor can be provided so as to be non-formed in sections.

5. The processing device according to claim 4, wherein that the formed electrical conductor can be separated into sections of specified length from the source of supply.

6. A device for receiving the electrical conductor provided or formed according to claim 3.

7. A device for outfitting a girder comprising a stator of the linear motor, of a magnetic levitation train, with the electrical conductor,
provided or formed by the processing device, and
received by the receiving device of claim 6.

8. The outfitting device according to claim 7, wherein the outfitting device is designed for wiring by means of sleeves, the respective phases (LL, ML, UL) of the sections of the electrical conductor.

9. The outfitting device according to claim 8, wherein at least two of the respective phases (LL, ML, UL) of the sections of the electrical conductor can be wired so as to alternate or be transposed so that the assembled electrical conductor comprises the three phases (LL, ML, UL) in even fractions; in particular follows:
approximately a third in the form of the first phase (LL),
approximately a third in the form of the second phase (ML), and
approximately a third in the form of the third phase (UL).

10. An installation device,
characterised by
at least one processing device,
at least one receiving device, and
at least one outfitting device according to claim 9.

11. The device according to claim 10, wherein the processing device is traversable across (Q), in particular essentially perpendicularly, in relation to a longitudinal axis of the girder to be outfitted, and wherein
the receiving device is traversable essentially along (L) the direction of the longitudinal axis of the girder to be outfitted.

12. The device according to claim 11, wherein at least parts of the device are accommodated in a girder outfitting hall.

13. The device according to claim 10, characterised in that the girder can be outfitted by means of at least two processing devices, wherein
at least one of the processing devices is designed for forming the electrical conductor according to a first forming type for first type of windings, and
at least a further one of the processing devices is designed for forming the electrical conductor according to a second forming type for second type of windings.

14. A method for processing a travelling-field electrical conductor for a linear motor, wherein said electrical conductor comprises at least one electrical line,
characterised in that:
the electrical conductor is
made available in a regulated manner from a source of supply, comprising at least one drum, or
formed in a controlled manner as an alignable, bendable, crimpable or windiable long stator winding (LSW).

15. The method according to claim 14, wherein the electrical conductor, at least in sections, is wound in three phases, in particular in
at least one first phase (LL),
at least one second phase (ML), and
at least one third phase (UL),
of a long stator winding (LSW).

16. The method according to claim 15, wherein for the provision of reduced drive output of the linear motor, the electrical conductor is provided so as to be non-formed, in sections, in corresponding pro-rata lengths.

17. The method according to claim 16, wherein the electrical conductor, after completion of the forming process,
is separated into sections of specified length, from the source of supply, and
is conveyed to a desired location of installation.

18. The method according to claim 17, wherein the electrical conductor is attached to, a girder comprising a stator of the linear motor of a magnetic levitation train.

19. The method according to claim 18, wherein the respective phases (LL, ML, UL) of the sections of the electrical conductor are interconnected by means of sleeves.

20. The method according to claim 19, wherein at least two of the respective phases (LL, ML, UL) of the sections of the electrical conductor are wired so as to alternate or be transposed so that the assembled electrical conductor comprises the three phases (LL, ML, UL) in even fractions; in particular is wound as follows:
approximately a third in the form of the first phase (LL),
approximately a third in the form of the second phase (ML), and
approximately a third in the form of the third phase (UL).

21. An electrical conductor, in particular a travelling-field conductor, for example a train of windings, that can be made available, in particular
formable, for example alignable and/or bendable and/or crimpable and/or windable, and/or
receivable and/or
affixable in at least one girder, in particular in at least one stator of at least one linear motor, for example in at least one carriageway girder that is essentially made of steel and/or of concrete, of a magnetic levitation train
by means of at least one processing device according to claim 5, and/or
by means of at least one receiving device according to claim 6, and/or
by means of at least one outfitting device according to claim 9, and/or
by means of at least one device according to claim 13, and/or
by means of the method according to claim 20.

22. The use of at least one processing device according to claim 5, and/or of at least one receiving device according to claim 6, and/or of at least one outfitting device according to claim 9, and/or of at least one device according to claim 13, and/or of the method according to claim 20 for producing and/or laying at least one electrical conductor of at least one linear motor, for example for producing and/or installing at least one, in particular single-phase and/or three-phase, train of windings, on and/or in at least one carriageway girder made of steel and/or made of concrete, of a magnetic levitation train.
